(19) United States
(12) Patent Application Publication
(10) Pub. No.: US 2015/0202556 A1
(43) Pub. Date: Jul. 23, 2015

(54) FILTER CARTRIDGE WITH FLOW PASSAGE IN ENDPLATE

(71) Applicant: Cummins Filtration IP, Inc., Columbus, IN (US)

(72) Inventors: Charles W. Hawkins, Sparta, TN (US); Bryan Herron, Cookeville, TN (US); Jignesh Rathod, Cookeville, TN (US); John P. Scheuren, Brentwood, TN (US); Kevin C. South, Cookeville, TN (US); Robert A. Bannister, Stoughton, WI (US); Benjamin L. Scheckel, Stoughton, WI (US)

(73) Assignee: Cummins Filtration IP, Inc., Columbus, IN (US)

(21) Appl. No.: 14/160,323

(22) Filed: Jan. 21, 2014

(51) Int. Cl. B01D 35/30; B01D 29/13; B01D 29/88

(52) U.S. Cl. CPC B01D 35/306; B01D 29/88; B01D 29/13

(57) ABSTRACT

A fluid filter assembly and a replaceable fluid filter cartridge are described where the fluid filter cartridge has an endplate that acts as a lid for the housing in which the fluid filter cartridge is installed. The endplate also includes a fluid flow passage formed therein through which filtered fluid exits or fluid to be filtered enters.

### CROSS-REFERENCE TO RELATED PATENT APPLICATIONS

This application which claims priority from U.S. Provisional Application No. 61/750,457, filed Jan. 9, 2013, the contents of which are incorporated herein by reference in its entirety.

### FIELD

This disclosure generally pertains to the field of filtration, and more particularly to a fluid filter cartridge with an endplate that acts as a lid for the housing in which the fluid filter cartridge is installed and that includes a fluid flow passage in the endplate.

### BACKGROUND

A filter housing typically has at least two ports (inlet and outlet) to direct fluid into the filter assembly, pushed/pulled through the filtration media, then directed back out of the assembly. Most designs have these two ports on the same component of the assembly, typically the housing, but they could also be on the lid of the housing.

Large lids for top load replaceable element filters can be difficult to remove after the service interval. This is due to the gasket and threads setting over the service interval with some fluid. These known designs also require that the whole lid and filter assembly be turned for installation or removal which places additional load on the filter element gaskets.

### SUMMARY

A fluid filter assembly and a replaceable fluid filter cartridge are described where the fluid filter cartridge has an endplate that acts as a lid for the housing in which the fluid filter cartridge is installed. The endplate also includes a fluid flow passage formed therein through which filtered fluid exits or fluid to be filtered enters.

When the fluid filter cartridge is used in an engine to filter fuel, the fluid filter cartridge prevents an operator from running the engine when no filter or an incorrectly designed filter is installed. This ensures that only correctly designed filters are used, protecting the engine and end user from inferior filtration products.

The filter is placed into the filter housing and sealed to an area that separates the dirty side from the clean side of the assembly. With this concept, the serviceable lid is integrated into the filter cartridge by the means of acting as the endplate of the filter cartridge. Also, the endplate defines a fluid passage for directing the fluid from the dirty to clean side of the assembly.

In any fluid application, in one embodiment the described design allows a more efficient delivery system for chemical additives which can be placed in the endplate area after the fluid has been filtered but before or during its exit through the fluid flow passage(s) in the endplate/lid.

In another embodiment, retention clamps described in U.S. Pat. No. 6,805,795 can be used that also lift the filter cartridge out of the housing. In addition, when the filter cartridge is lifted upwardly, a drain port can be opened to allow draining of fluid from the filter housing for cleaner service events.

In another embodiment, the interface between the endplate/lid and the housing can include engaged ramps that act to position the endplate/lid for clamping and can aid in removal of the cartridge. The ramps help to lift the cartridge upwardly when it is rotated relative to the housing.

In one embodiment, a fluid filter cartridge includes filtration media having a first end, a second end, a filtered fluid side, and an unfiltered fluid side. A first endplate is sealingly attached to the first end of the filtration media, and a combined endplate/housing lid is sealingly attached to the second end of the filtration media. The combined endplate/housing lid includes a perimeter edge, a first seal is on the combined endplate/housing lid and positioned to seal unfiltered fluid from filtered fluid, and a second seal is on the combined endplate/housing lid that is axially spaced from the first seal and positioned to prevent fluid leakage from a housing in which the fluid filter cartridge is installed. At least one fluid flow passage is formed in the combined endplate/housing lid, with the fluid flow passage including one end in fluid communication with either the filtered fluid side or the unfiltered fluid side of the filtration media and a second end that extends through the perimeter edge, and the second end of the fluid flow passage is positioned between the first seal and the second seal.

In another embodiment, a fluid filter assembly includes a filter housing having first and second fluid flow ports, and the fluid filter cartridge removably installed within the filter housing.

### DRAWINGS

FIG. 1 is a cross-sectional view of one embodiment of a fluid filter cartridge described herein installed within a housing.

FIG. 2 is a perspective view of the fluid filter cartridge of FIG. 1.

FIG. 3 is a cross-sectional view of another embodiment of a fluid filter cartridge described herein installed within a housing.

FIG. 4 is a cross-sectional view similar to FIG. 3 but rotated 90 degrees.

FIG. 5 is a perspective view of the fluid filter cartridge of FIGS. 3-4.

FIG. 6 is a view similar to FIG. 3 but with the fluid filter lifted upwardly to drain the housing.

FIG. 7 is a perspective view of the filter assembly of FIGS. 3-4.

FIG. 8 is a close-up view of a portion of the lid and housing of the filter assembly contained with circle 8 of FIG. 7.

### DETAILED DESCRIPTION

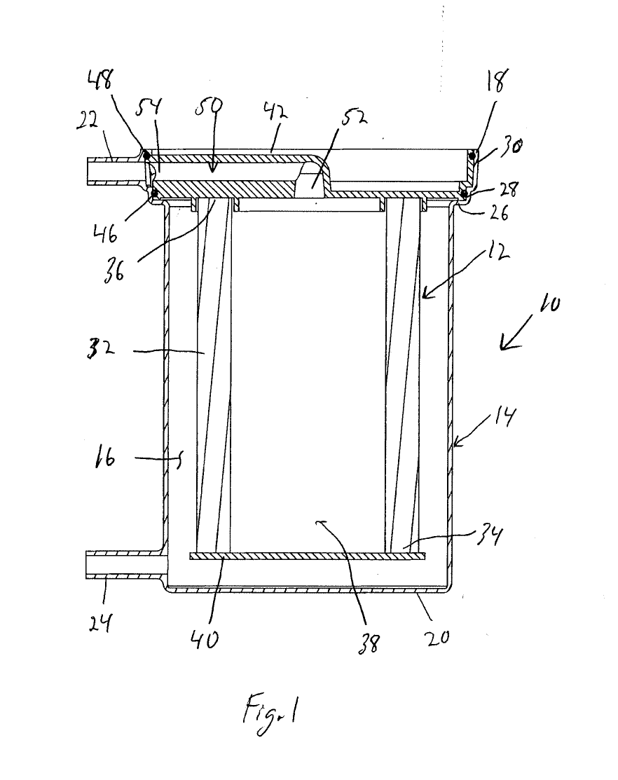

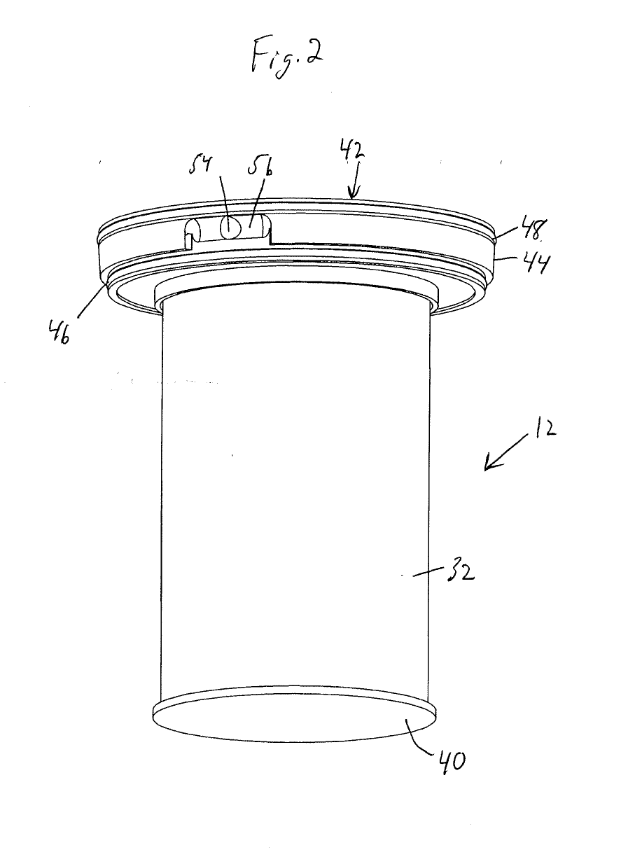

With reference initially to FIGS. 1-2, a filter assembly 10 that includes a first embodiment of a fluid filter cartridge 12 installed within a filter housing 14 is illustrated. The filter assemblies described herein can be used in any number of fluid systems including, but not limited to, a fuel or oil filtration system, for example on an engine such as a diesel or gasoline engine, a hydraulic fluid filtration system in a hydraulic system, other engine fluid filtration systems on diesel or gasoline engines, as well as filtration systems used in non-engine applications. In one exemplary application, the filter assemblies described herein are used in a fuel system for filtering fuel, for example diesel fuel.

In the illustrated example, the filter housing 14 defines an interior space 16 that receives the filter cartridge 12. In this embodiment, during servicing, the housing 14 is intended to be reused and the filter cartridge 12 is removed and replaced with a new filter cartridge. The housing 14 can be made of any material suitable for use in a fluid filter. Examples of materials include metal and plastic. The housing 14 can be generally cylindrical in shape and includes a wall having a first, open end 18 and a second, closed end 20. However, housing shapes other than cylindrical can be used.

The housing 14 also includes a first fluid flow port 22 and a second fluid flow port 24. The first fluid flow port 22 can be either an exit port for filtered fluid or an input port for fluid to be filtered, while the second fluid flow port 24 can be either an input port for fluid to be filtered or an exit port for filtered fluid. In one embodiment, the first fluid flow port 22 is an exit port for filtered fluid and the second fluid flow port 24 is an input port for fluid to be filtered.

The housing 14 also includes an interior shelf 26 adjacent to the open end 18 that faces upwardly in an axial direction away from the closed end 20 of the shell. In use, the shelf 26 supports the endplate of the filter cartridge 12 to axially position the filter cartridge 12 as discussed further below. However, the interior shelf 26 is optional and other means can be used to axially position the filter cartridge in the housing. For example, the bottom endplate of the filter cartridge can be designed to engage with the housing to axially position the filter cartridge. The housing 14 further includes a first circumferentially continuous, interior sealing surface 28 and a second circumferentially continuous, interior sealing surface 30 disposed on opposites sides of the fluid flow port 22.

With continued reference to FIGS. 1-2, the filter cartridge 12 includes filtration media 32 having a first end 34 and a second end 36, an unfiltered fluid side that in use faces fluid that is to be filtered by the filtration media and a filtered fluid side to which the fluid flows after flowing through and being filtered by the filtration media. In the illustrated example, the filtration media 32 is ring-shaped and circumscribes a central cavity 38 having a longitudinal axis. Although the filtration media 32 has been described and illustrated as being in the form of a ring, filtration media that is not of ring-shape design can be used, such as a folded filtration media pack and other non-ring-shaped filtration media designs. In addition, the ring-shaped media can take on any shape, for example a cylindrical ring, triangular ring, oval ring, or the like as long as it defines a central cavity.

A first endplate 40 is sealingly attached to the first end 34 of the filtration media 32, and a combined endplate/housing lid 42 is sealingly attached to the second end 36 of the filtration media. In the illustrated example, the first endplate 40 is a closed endplate in that there are no flow passages through the endplate 40 and fluid cannot flow through the endplate 40. The endplate 40 can be attached to the first end 34 in any suitable manner, such as using an adhesive or the first end 34 can be embedded into the endplate 40.

The combined endplate/housing lid 42 acts as both an endplate for the filter cartridge and as a lid to close the open end 18 of the housing 14. The combined endplate/housing lid 42 can be attached to the second end 36 in any suitable manner, such as using an adhesive or the second end 36 can be embedded into the combined endplate/housing lid 42.

The combined endplate/housing lid 42 includes a perimeter edge 44. A first elastomeric, circumferentially continuous sealing gasket 46 is provided on the combined endplate/housing lid 42 adjacent to the perimeter edge 44. The gasket 46 is positioned and configured to seal with the sealing surface 28 when the filter cartridge is installed in the housing to seal unfiltered fluid from filtered fluid. In addition, a second elastomeric, circumferentially continuous sealing gasket 48 is provided on the combined endplate/housing lid adjacent to the perimeter edge 44. The gasket 48 is axially spaced from the first sealing gasket 46 and is positioned and configured to seal with the sealing surface 30 to prevent fluid leakage from the housing 14. Other types of seals that perform a sealing function can be used instead of the sealing gaskets 46, 48. For example, non-elastomeric seals including but not limited to felt can be used or seals can be integrally formed, for example co-molded, with the combined endplate/housing lid 42.

In addition, at least one fluid flow passage 50 is formed in the combined endplate/housing lid 42. Only one fluid flow passage 50 is illustrated in this example; however a plurality of similar fluid flow passages can be provided. In the illustrated embodiment, the fluid flow passage 50 extends substantially radially through the combined endplate/housing lid 42 perpendicular to the longitudinal axis and includes one end 52 that is in fluid communication with either the filtered fluid side of the filtration media, for example the central cavity 38 of the ring of filtration media 32, if the fluid flow passage 50 acts as an outlet passage for filtered fluid, or in fluid communication with the unfiltered fluid side of the filtration media if the fluid flow passage 50 acts as an inlet flow passage for fluid to be filtered. In addition, the fluid flow passage 50 includes a second end 54 that extends through the perimeter edge 44 between the sealing gaskets 46, 48. In one embodiment, the end 52 of the fluid flow passage 50 is disposed at a center of the combined endplate/housing lid 42.

With reference to FIG. 2, the perimeter edge 44 can include a circumferentially extending recessed area 56 that extends on each side of the second end 54 of the fluid flow passage 50. This accounts for variations in the position of the combined endplate/housing lid 42 when it is installed so that the fluid flow passage 50 remains in fluid communication with the fluid flow port 22. The cartridge 12 can be assembled to the housing 14 in a number of ways. The cartridge 12 can be a quarter turn style that is keyed to only go into the housing one way or a thread interface could be used with or without a specific thread start or no keying item. Alternatively, the recessed area 56 could extend completely around the perimeter edge 44 so that the fluid flow passage 50 is always in fluid communication with the port 22 to permit the cartridge to be installed into the housing in any orientation.

In use of the assembly 10, assuming the port 22 is an exit port for filtered fluid and the port 24 is an input port for fluid to be filtered, fluid to be filtered flows into the housing 14 via the port 24 to the unfiltered fluid side of the filtration media 32. The fluid then flows through the filtration media 32 and then into the central cavity 38 which forms the filtered fluid side. The now-filtered fluid then flows through the fluid flow passage 50 and out the port 22 to the engine or other location. At the end of the service life of the cartridge 12, the cartridge is removed from the housing 14 and a new cartridge installed.

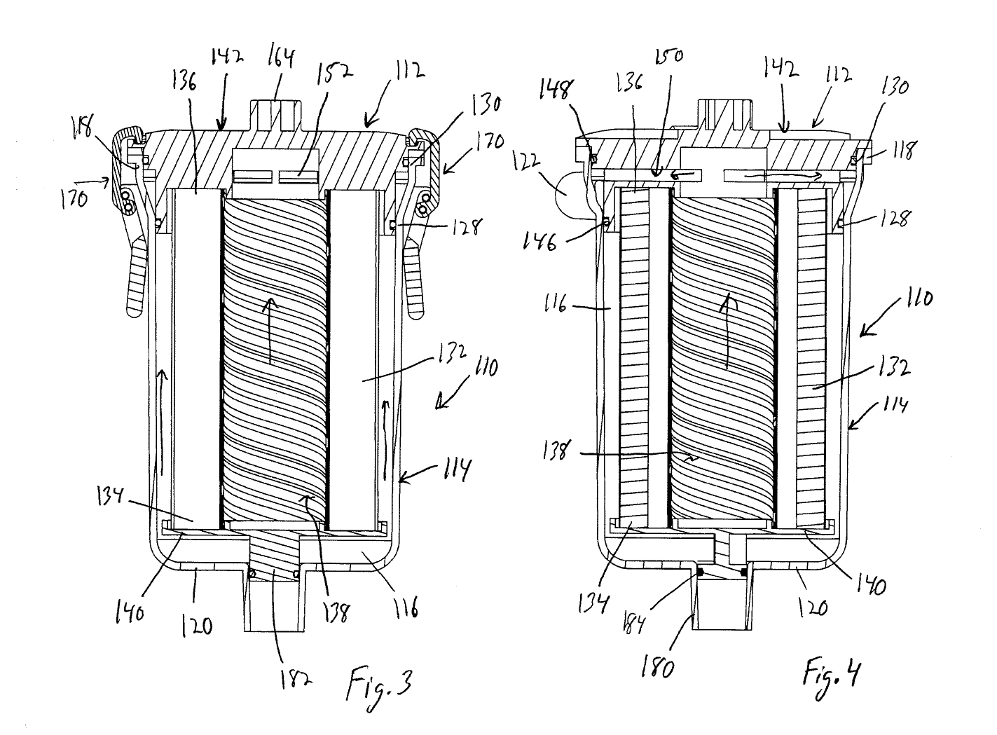

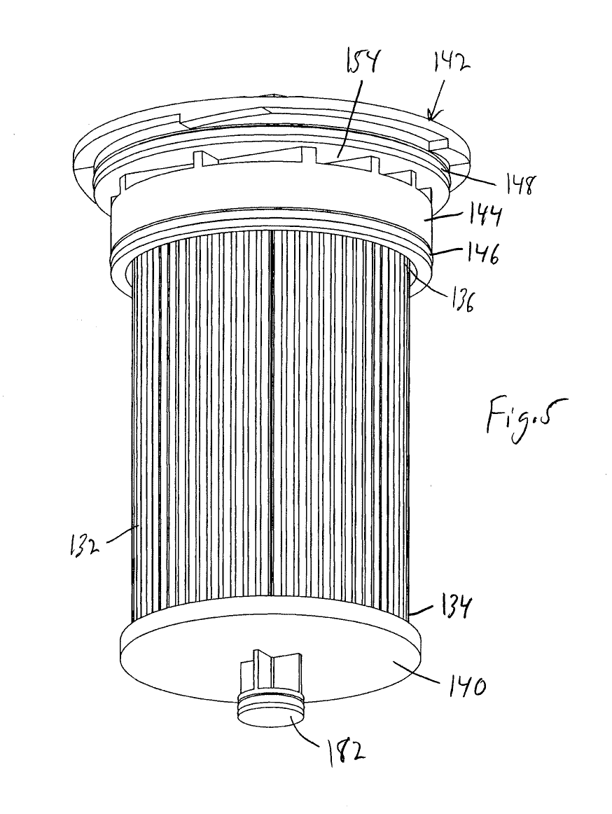

Turning to FIGS. 3-8, another embodiment of a filter assembly 110 is illustrated that includes a fluid filter cartridge 112 installed within a filter housing 114. In the illustrated example, the filter housing 114 defines an interior space 116 that receives the filter cartridge 112. In this embodiment, during servicing, the housing 114 is intended to be reused and the filter cartridge 112 is removed and replaced with a new filter cartridge. The housing 114 can be made of any material suitable for use in a fluid filter. Examples of materials include metal and plastic. The housing 114 can be generally cylindrical in shape and includes a wall having a first, open end 118 and a second, closed end 120.

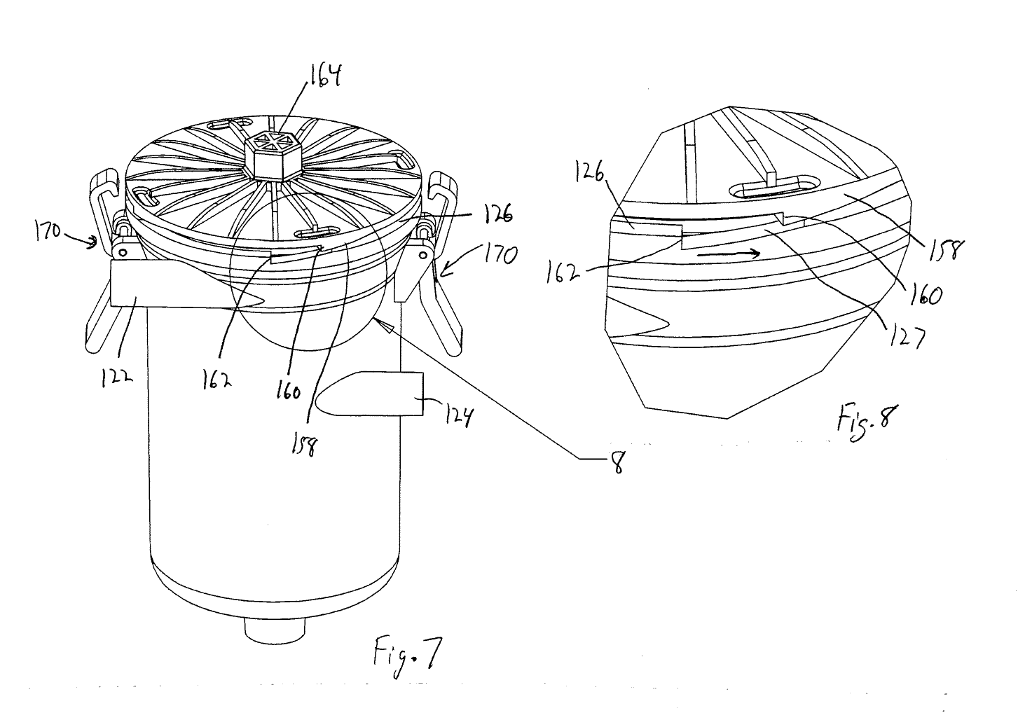

The housing 114 also includes a first fluid flow port 122 and a second fluid flow port 124 (best seen in FIG. 7). The first fluid flow port 122 can be either an exit port for filtered fluid or an input port for fluid to be filtered, while the second fluid flow port 124 can be either an input port for fluid to be filtered or an exit port for filtered fluid. In one embodiment, the first fluid flow port 122 is an exit port for filtered fluid and the second fluid flow port 124 is an input port for fluid to be filtered.

As best seen in FIGS. 7 and 8, the housing 114 also includes an axial edge 126 at the open end 118 that faces upwardly in an axial direction away from the closed end 120 of the shell. The edge 126 includes a plurality of ramp surfaces 127 (discussed further below) that in use are engaged with ramp surfaces (described below) on the cartridge. In use, the edge 126 supports the endplate of the filter cartridge 112 as discussed further below.

Returning to FIGS. 3-4, the housing 114 further includes a first circumferentially continuous, interior sealing surface 128 and a second circumferentially continuous, interior sealing surface 130 disposed on opposites sides of the fluid flow port 122.

With reference to FIGS. 3-5, the filter cartridge 112 includes filtration media 132 having a first end 134 and a second end 136, an unfiltered fluid side that in use faces fluid that is to be filtered by the filtration media and a filtered fluid side to which the fluid flows after flowing through and being filtered by the filtration media. In the illustrated example, the filtration media 132 is ring-shaped and circumscribes a central cavity 138 having a longitudinal axis. Although the filtration media 132 has been described and illustrated as being in the form of a ring, filtration media that is not of ring-shape design can be used, such as folded a filtration media pack and other non-ring-shaped filtration media designs.

A first endplate 140 is sealingly attached to the first end 134 of the filtration media 132, and a combined endplate/housing lid 142 is sealingly attached to the second end 136 of the filtration media. In the illustrated example, the first endplate 140 is a closed endplate in that there are no flow passages through the endplate 140 and fluid cannot flow through the endplate 140. The endplate 140 can be attached to the first end 134 in any suitable manner, such as using an adhesive or potting compound or the first end 134 can be embedded into the endplate 140.

The combined endplate/housing lid 142 acts as both an endplate for the filter cartridge and as a lid to close the open end 118 of the housing 114. The combined endplate/housing lid 142 can be attached to the second end 136 in any suitable manner, such as using an adhesive or potting compound or the second end 136 can be embedded into the combined endplate/housing lid 142.

The combined endplate/housing lid 142 includes a perimeter edge 144. A first elastomeric, circumferentially continuous sealing gasket 146 is provided on the combined endplate/housing lid 142 adjacent to the perimeter edge 144. The gasket 146 is positioned and configured to seal with the sealing surface 128 when the filter cartridge is installed in the housing to seal unfiltered fluid from filtered fluid. In addition, a second elastomeric, circumferentially continuous sealing gasket 148 is provided on the combined endplate/housing lid adjacent to the perimeter edge 144. The gasket 148 is axially spaced from the first sealing gasket 146 and is positioned and configured to seal with the sealing surface 130 to prevent fluid leakage from the housing 114. Other types of seals that perform a sealing function can be used instead of the sealing gaskets 146, 148. For example, non-elastomeric seals including but not limited to felt can be used, or seals can be integrally formed, for example co-molded, with the combined endplate/housing lid 142.

In addition, at least one fluid flow passage 150 is formed in the combined endplate/housing lid 142. In the illustrated example, a plurality of the fluid flow passages 150 are provided, however it is to be realized that a single fluid flow passage 150 could be used. In the illustrated embodiment, each of the fluid flow passages 150 extends substantially radially through the combined endplate/housing lid 142 perpendicular to the longitudinal axis and each passage 150 includes one end 152 that is in fluid communication with either the filtered fluid side of the filtration media, for example the central cavity 138 of the ring of filtration media 132, if the fluid flow passage 150 acts as an outlet passage for filtered fluid, or in fluid communication with the unfiltered fluid side of the filtration media if the fluid flow passage 150 acts as an inlet flow passage for fluid to be filtered. In addition, the fluid flow passage 150 includes a second end 154 that extends through the perimeter edge 144 between the sealing gaskets 146, 148. In one embodiment, the ends 152 of the fluid flow passages 150 are disposed at a center of the combined endplate/housing lid 142.

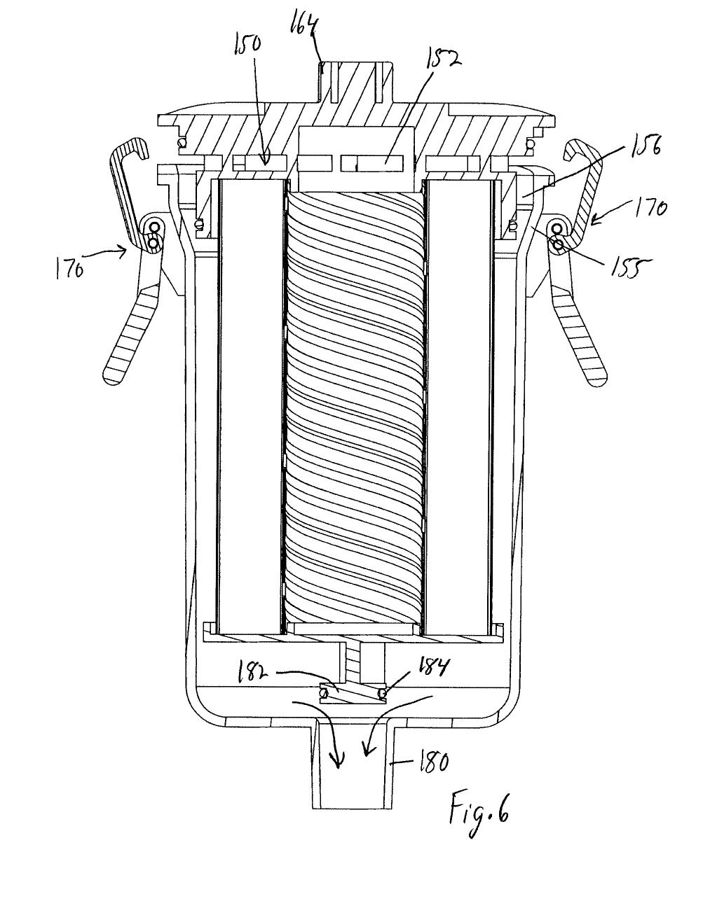

With reference to FIG. 6, the open end of the housing 114 between the sealing surfaces 128, 130 is flared outwardly 155 to define a circumferentially extending fluid area 156 that is in fluid communication with the second ends 154 of the flow passages 150 and in fluid communication with the port 122. With this construction, the filter cartridge 112 can be installed into the housing 114 in any orientation and a keying system is not required.

As best seen in FIGS. 7 and 8, in one embodiment the combined endplate/housing lid 142 includes a plurality of circumferentially spaced ramp surfaces 158 at the perimeter edge 144. The ramp surfaces 158 face in an axial direction toward the first endplate 140, and the second sealing gasket 148 is disposed between the ramp surfaces 158 and the first sealing gasket 146. When the cartridge 112 is fully installed, the ramp surfaces 158 engage with the ramp surfaces 127 on the edge 126 of the housing. At this position, a shoulder 160 at the end of each ramp surface 158 engages with a similar shoulder 162 at the end of each ramp surface 127 to define a stop. When the filter cartridge 112 is rotated relative to the housing 114 in the direction of the arrow in FIG. 8, the ramp surfaces 158 ride up the ramp surfaces 127 on the edge of the housing which forces the filter cartridge axially upward to help remove the filter cartridge from the housing.

Optionally, rotation of the filter cartridge 112 can be facilitated by a tool engagement feature 164, for example a hexagonal protrusion, that projects upwardly from the combined endplate/housing lid 142 that is configured to engage with a tool for rotating the cartridge 112 relative to the housing 114. Instead of a protrusion, a tool receiving recess can be formed in the combined endplate/housing lid 142. In addition, the tool engagement feature can have any shape that is suitable for engaging with a tool for rotating the cartridge 112.

With reference to FIGS. 3-4 and 6-7, either in addition to or separately from the ramp surfaces 127, 158, retention/extraction clamps 170 can be provided. The clamps 170 help to secure the filter cartridge to the housing. In addition, the clamps 170 can help to lift the filter cartridge upwardly during servicing. Further information on such clamps can be found in U.S. Pat. No. 6,805,795, which is incorporated herein by reference in its entirety.

In addition, separately from or in addition to the previously described features, the closed end 120 of the housing 114 can include a drain passageway 180 that can be fluidly connected to a drain reservoir, such as a fuel tank. The first endplate 140 includes a drain plug 182 that can be integrally formed therewith or otherwise suitably attached to the endplate 140. The drain plug 182 extends from the first endplate 140 in an axial direction parallel, and coaxial, to the longitudinal axis away from the combined endplate/housing lid 142. As shown in FIGS. 3-4, the drain plug 182 is configured to be received within the drain passageway 180 when the filter cartridge is fully installed in the housing. However, as shown in FIG. 6, when the filter cartridge is lifted upward for removal during servicing, the drain plug is removed from the drain passageway, permitting fluid within the housing to drain through the drain passageway 180. The drain plug 182 includes a sealing gasket 184 that seals with the drain passageway 180 when the filter cartridge is fully installed to prevent fluid leakage past the drain plug 182.

In use of the assembly 110, assuming the port 122 is an exit port and the port 124 is an input port, fluid to be filtered flows into the housing 114 via the port 124 and to the unfiltered fluid side of the filtration media. The fluid then flows through the filtration media 132 and then into the central cavity 138 which forms the filtered fluid side of the filtration media. The now-filtered fluid then flows through the fluid flow passage 150 and out the port 122 to the engine or other location. At the end of the service life of the cartridge 112, the cartridge is removed from the housing 114 and new cartridge installed.

In both filter assemblies 10, 110 and in any fluid application of the filter assemblies, the described design allows a more efficient delivery system for chemical additives which can be placed in the combined endplate/housing lid. This would allow introduction of one or more chemical additives into the fluid after the fluid has been filtered but before or during its exit through the horizontal passage(s) in the combined endplate/lid.

The features of the embodiment illustrated in FIGS. 1-2 can be used in any combination with the embodiment illustrated in FIGS. 3-8. In addition, the features of the embodiment illustrated in FIGS. 3-8 can be used in any combination with the embodiment illustrated in FIGS. 1-2.

In addition, the drain plug/drain passageway feature, the retention/extraction clamps feature, and the ramp surfaces feature described with respect to FIGS. 3-8 can be used individually or in any combination thereof on the filter assembly 110 or on the filter assembly 10 of FIGS. 1-2.

The described embodiment(s) may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A fluid filter cartridge, comprising:
filtration media having a first end, a second end, a filtered fluid side, and an unfiltered fluid side;
a first endplate sealingly attached to the first end of the filtration media;
a combined endplate/housing lid sealingly attached to the second end of the filtration media, the combined endplate/housing lid including a perimeter edge;
a first seal on the combined endplate/housing lid, the first seal positioned to seal unfiltered fluid from filtered fluid;
a second seal on the combined endplate/housing lid, the second seal is axially spaced from the first seal and positioned to prevent fluid leakage from a housing in which the fluid filter cartridge is installed; and
at least one fluid flow passage formed in the combined endplate/housing lid, the fluid flow passage including one end in fluid communication with either the filtered fluid side or the unfiltered fluid side of the filtration media and a second end that extends through the perimeter edge, the second end of the fluid flow passage is positioned between the first seal and the second seal.

2. The fluid filter cartridge of claim 1, wherein the fluid flow passage is a horizontal fluid flow passage that extends perpendicular to a longitudinal axis of the filtration media.

3. The fluid filter cartridge of claim 1, wherein the one end of the fluid flow passage is disposed at a center of the combined endplate/housing lid.

4. The fluid filter cartridge of claim 1, comprising a plurality of the fluid flow passages formed in the combined endplate/housing lid.

5. The fluid filter cartridge of claim 1, wherein the combined endplate/housing lid includes a plurality of spaced ramp surfaces adjacent to the perimeter edge, the ramp surfaces face in an axial direction toward the first endplate, and the second seal is disposed between the ramp surfaces and the first seal.

6. The fluid filter cartridge of claim 1, wherein the first endplate includes a drain plug integrally formed therewith, the drain plug extends from the first endplate in an axial direction parallel to a longitudinal axis of the filtration media away from the combined endplate/housing lid.

7. The fluid filter cartridge of claim 1, wherein the fluid flow passage forms a fluid outlet passage through which filtered fluid that has been filtered by the filtration media flows.

8. The fluid filter cartridge of claim 1, wherein the first endplate is closed with no flow passages through the first endplate.

9. The fluid filter cartridge of claim 1, wherein the second seal is disposed on a portion of the combined endplate/housing lid that has a diameter that is greater than a diameter of a portion of the combined endplate/housing lid that the first seal is disposed on.

10. The fluid filter cartridge of claim 1, further comprising a tool engagement feature that projects from the combined endplate/housing lid in a direction away from the first endplate, the tool engagement tool is configured to engage with a tool for rotating the fluid filter cartridge.

11. A fluid filter assembly, comprising:
a filter housing having first and second fluid flow ports, one of the first and second fluid flow ports forming a fluid inlet for fluid to be filtered and the other of the first and second fluid flow ports forming a fluid outlet for filtered fluid;
a fluid filter cartridge removably installed within the filter housing, the fluid filter cartridge includes:
filtration media having a first end, a second end, a filtered fluid side, and an unfiltered fluid side;
a first endplate sealingly attached to the first end of the filtration media;
a combined endplate/housing lid sealingly attached to the second end of the filtration media, the combined endplate/housing lid including a perimeter edge;
a first seal on the combined endplate/housing lid, the first seal sealing with the filter housing to seal unfiltered fluid from filtered fluid;
a second seal on the combined endplate/housing lid, the second seal is axially spaced from the first seal and sealing with the filter housing to prevent fluid leakage from the filter housing; and
at least one fluid flow passage formed in the combined endplate/housing lid, the fluid flow passage including one end in fluid communication with either the filtered fluid side or the unfiltered fluid side of the filtration media and a second end that extends through the perimeter edge, the second end of the fluid flow passage is positioned between the first seal and the second seal, and the second end is in fluid communication with the first fluid flow port.

12. The fluid filter assembly of claim 11, wherein the fluid flow passage is a horizontal fluid flow passage that extends perpendicular to a longitudinal axis of the filtration media.

13. The fluid filter assembly of claim 11, wherein the one end of the fluid flow passage is disposed at a center of the combined endplate/housing lid.

14. The fluid filter assembly of claim 11, comprising a plurality of the fluid flow passages formed in the combined endplate/housing lid.

15. The fluid filter assembly of claim 11, wherein the combined endplate/housing lid includes a plurality of spaced ramp surfaces adjacent to the perimeter edge, the ramp surfaces face in an axial direction toward the first endplate, and the second seal is disposed between the ramp surfaces and the first seal; and
the filter housing includes an edge adjacent to the combined endplate/housing lid, the edge includes a plurality of ramp surfaces that are engaged with the ramp surfaces on the combined endplate/housing lid.

16. The fluid filter assembly of claim 11, wherein the first endplate includes a drain plug integrally formed therewith, the drain plug extends from the first endplate in an axial direction parallel to a longitudinal axis of the filtration media away from the combined endplate/housing lid; and
the filter housing includes a drain passageway that receives the drain plug.

17. The fluid filter assembly of claim 11, wherein the fluid flow passage forms a fluid outlet passage through which filtered fluid that has been filtered by the filtration media flows, and the first fluid flow port receives filtered fluid and the second fluid flow port receives fluid to be filtered.

18. The fluid filter assembly of claim 11, wherein the first endplate is closed with no flow passages through the first endplate.

19. The fluid filter assembly of claim 11, wherein the second seal is disposed on a portion of the combined endplate/housing lid that has a diameter that is greater than a diameter of a portion of the combined endplate/housing lid that the first seal is disposed on.

20. The fluid filter assembly of claim 11, further comprising a tool engagement feature that projects from the combined endplate/housing lid in a direction away from the first endplate, the tool engagement tool is configured to engage with a tool for rotating the fluid filter cartridge relative to the filter housing.
